(19) United States
(12) Patent Application Publication
(10) Pub. No.: US 2018/0354826 A1
(43) Pub. Date: Dec. 13, 2018

(54) METHODS AND APPARATUS FOR A WATER PURIFICATION SYSTEM

(71) Applicant: Michael J. Geyer, Tempe, AZ (US)

(72) Inventor: Michael J. Geyer, Tempe, AZ (US)

(21) Appl. No.: 16/105,278

(22) Filed: Aug. 20, 2018

Related U.S. Application Data
(63) Continuation-in-part of application No. 15/355,354, filed on Nov. 18, 2016.
(60) Provisional application No. 62/256,828, filed on Nov. 18, 2015.

(51) Int. Cl. C02F 1/72; C02F 1/00

(52) U.S. Cl. CPC C02F 1/727; C02F 2103/42; C02F 2201/005; C02F 1/008

(57) ABSTRACT

A water purification system according to various embodiments of the present technology is configured to regulate the flow rate of the water and infuse the water with oxygen. The water purification system may comprise various valves, fittings, couplings, pumps, and filters configured to remove debris from the water and regulate the flow of the water through various filters. The water purification system may comprise a controller to electrically control various valves and pumps. The water purification system may comprise a device for infusing the water with oxygen.

### CROSS-REFERENCE TO RELATED APPLICATION

This application is a continuation-in-part of U.S. patent application Ser. No. 15/355,354, filed on Nov. 18, 2016, which claims priority to U.S. Provisional Patent Application Ser. No. 62/256,828, filed on Nov. 18, 2015.

### BACKGROUND OF THE INVENTION

Commercial and residential swimming pools, diving pools, hot tubs, spas, and the like, require circulation systems and chemical treatment systems to sanitize the water, balance the pH, and remove impurities. Many conventional systems utilize chlorine to sanitize the water, however, water treated with chlorine has a chemical taste and odor, and is drying to the skin and hair. In addition, to the cost of the various chemicals needed to maintain the water, chlorine is corrosive and may damage various mechanical elements within the treatment system. As such, traditional chemicals have an impact on the operational costs of pools and spas. Therefore, a reduction in the amount of chemicals needed for sanitizing, pH-balancing and the like, may reduce the operational costs.

### SUMMARY OF THE TECHNOLOGY

A water purification system according to various embodiments of the present technology is configured to regulate the flow rate of the water and infuse the water with oxygen. The water purification system may comprise various valves, fittings, couplings, pumps, and filters configured to remove debris from the water and regulate the flow of the water through various filters. The water purification system may comprise a controller to electrically control various valves and pumps. The water purification system may comprise a device for infusing the water with oxygen.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures. For simplicity and clarity of illustration, elements in the figures are not necessarily drawn to scale.

FIG. 1 representatively illustrates a block diagram of a water purification system in accordance with a first embodiment of the present technology;

FIGS. 2A and 2B representatively illustrate a gas injector system in accordance with various embodiments of the present technology;

FIG. 3 representatively illustrates the gas injector system in accordance with various embodiments of the present technology;

FIG. 4 representatively illustrates the gas injector system in accordance with various embodiments of the present technology;

FIG. 5 representatively illustrates an exploded view of the gas injector system in accordance with various embodiments of the present technology; and

FIG. 6 is a flow chart of a water purification system in accordance the first embodiment of the present technology; and

FIG. 7 representatively illustrates a block diagram of a water purification system in accordance with a second embodiment of the present technology.

### DETAILED DESCRIPTION OF THE DRAWINGS

The present technology may be described in terms of functional block components and various processing steps. Such functional blocks may be realized by any number of components configured to perform the specified functions and achieve the various results. For example, the present technology may employ various types of connectors, couplings, tubing, conduit, valves, regulators, pumps, nozzles, liquid and/or chemical tanks and/or hoppers, and the like, which may carry out a variety of functions. In addition, the present technology may be practiced in conjunction with any number of systems such as residential, commercial, and/or industrial chemical treatment systems and the system described is merely one exemplary application for the technology. Further, the present technology may employ any number of conventional techniques for distributing and/or mixing chemicals, measuring and/or sensing a liquid and/or chemical amount and/or concentration, controlling fluid flow, controlling valves, pumps, coupling valves, conduit, nozzles, regulators, and the like.

Methods and apparatus for a water purification system according to various aspects of the present technology may operate in conjunction with any suitable secondary chemical treatment systems and/or aquatic application. Various representative implementations of the present technology may be applied to any filtration and/or treatment system for a pool, such as chlorine or salt.

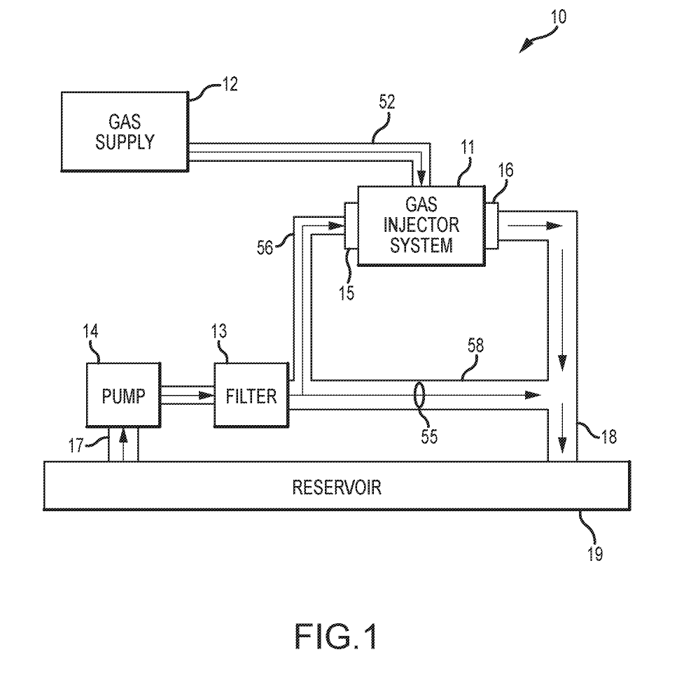

Referring to FIG. 1, a water purification system 10 in accordance with an embodiment of the present technology may pump water from a water source, filter the water, and inject gas into the water. The water purification system 10 may comprise a first conduit 17, a pump 14, a first filter 13, a gas injector system 11, a gas supply 12, a reservoir 19, and one or more components configured to facilitate the flow of a liquid into and out of the reservoir 19. The reservoir 19 may comprise any suitable source of liquid (e.g., water) such as a swimming pool, fountain, pond, spa, or the like. Infusing the liquid with oxygen may provide a system with a secondary purification treatment method. For example, a pool may use chlorine as the primary treatment method, but may use the gas injector system 11 as a secondary purification treatment method in conjunction with chlorine. Oxygen-infused water may also provide a more appealing aquatic environment. For example, in a swimming pool that uses chlorine as the primary treatment method, which is known to have a strong chemical odor and dries the skin, the water may have no odor or a reduced chemical odor and may be less drying to the skin of swimmers.

The pump 14 facilitates flow of the liquid from the reservoir 19 to the water purification system 10. The pump 14 may comprise any suitable system or device for moving the liquid from the source to the water purification system 10. For example, the pump 14 may be configured to receive water from a swimming pool via the conduit 17 and generate a sufficient flow rate of water to the water purification system 10 and back to the swimming pool through a return outlet 18. The pump 14 may comprise any suitable size and may be selected according to any suitable criteria such as desired application, desired flow rate, operating pressure, source of liquid, or function. For example, the pump 14 may comprise an electrical pump powered by an external power supply and be configured to provide a specific output power, fixed or adjustable flow rate, or other suitable criteria.

The first filter 13 may remove debris from the liquid, such as yard waste, dirt, sand, insects, or any other material that may cause obstructions in or damage to the system if allowed to pass through. The first filter 13 may comprise any suitable type of device or system for filtering a liquid. The first filter 13 may be positioned downstream of the pump 14 to receive and filter the liquid before it flows to the gas injector system 11. The first filter 13 may be constructed of any suitable material and may be of any suitable size based on the size and type of components of the water purification system 10, the pressure and/or flow requirements for the liquid flowing into and/or out of the water purification system 10, or any other relevant factor.

The gas supply 12 provides an external source of a gas to the water purification system 10. The gas supply 12 may comprise a concentrated gas and/or pressurized gas, such as oxygen, suitable for mixing with water. For example, water that enters the gas injector system 11 may be mixed with oxygen from the gas supply 12. The oxygen-infused water then leaves the gas injector system 11 through an outlet 16 (i.e., a main outlet). The oxygen-infused water may then be returned to the reservoir 19 through the return outlet 18.

The gas injector system 11 injects the gas from the gas supply 12 into the water flowing through the gas injector system. The gas injector system 11 may be configured to generate sub-micron, gas-containing cavities (nano-bubbles, and also referred to as ultra-fine bubbles) to produce oxygen-infused water. The nano-bubbles alter behavioral characteristics of the liquid because they are less buoyant and remain suspended in the liquid for extended periods of time, unlike other aeration systems where the larger sized air bubbles disappear rapidly due to more rapidly rising to the surface of the liquid and bursting. The gas injector system 11 may generate nano-bubbles that measure at less than 1 micron (micrometer) in diameter to maintain the cohesion between the water molecules and/or maintain the surface tension of the water. For example, in one embodiment, the nano-bubbles may range in diameter from 70 nm (nanometers) to 125 nm. In a second embodiment, the gas injector system 11 may generate nano-bubbles that measure approximately 107 nm in diameter. In a third embodiment, the gas injector system 11 may be configured to generate varying sizes of nano-bubbles measuring less than 700 nm.

The gas injector system 11 may be positioned downstream of the first filter 13. In one embodiment, the gas injector system 11 may be connected downstream of the first filter 13 via a primary conduit 56, such that after the liquid is cleaned by the first filter 13, the liquid enters the gas injector system 11 through an inlet 15 (i.e., a main inlet). The gas injector system 11 may be further coupled to the gas supply 12 via a feed hose 52.

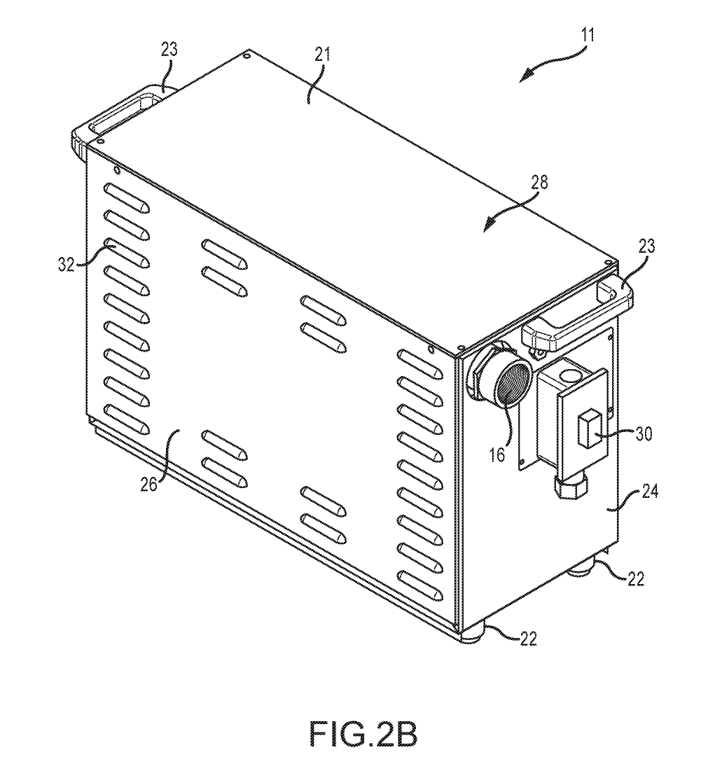

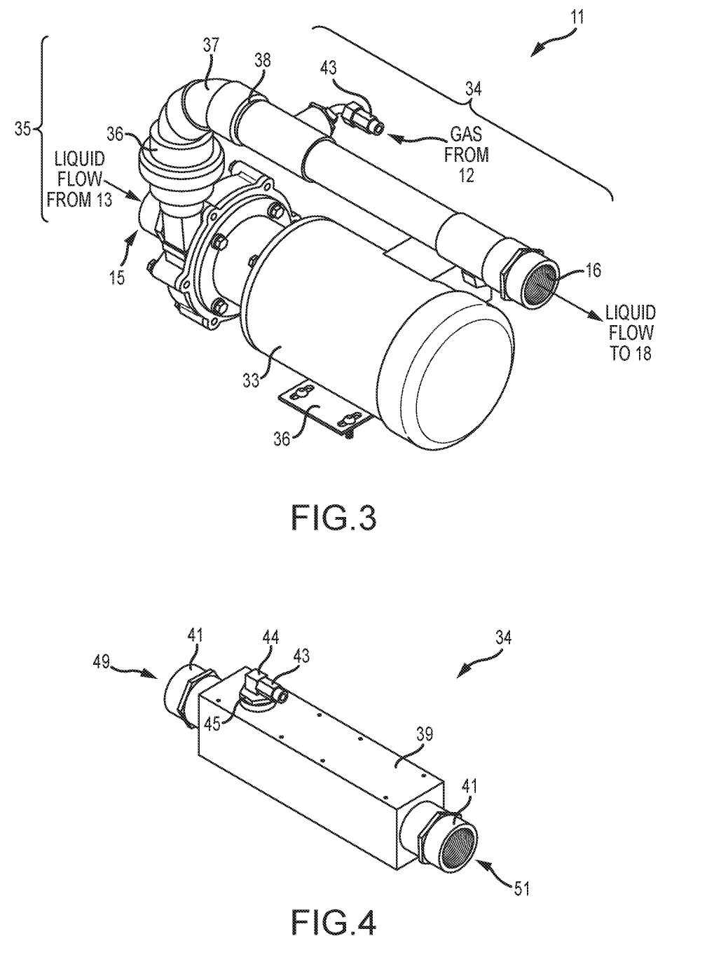

Referring to FIGS. 3, 4, and 5, the gas injector system 11 may comprise an injector pump 33, a fixture 34, and one or more connectors 35. The injector pump 33 may be used in conjunction with the pump 14 of the water purification system 10 to accelerate the liquid to the fixture 34. The injector pump 33 may comprise any suitable system or device for moving a liquid such as an electrical pump powered by an external power supply. The injector pump 33 may be selected according to any suitable criteria such as a desired output power, the size and type of components of the water purification system 10, the pressure and/or flow requirements for the liquid flowing into and/or out of the water purification system 10, or any other relevant factor.

The injector pump 33 may further comprise a mount 36 to provide stability to the gas injector system 11. In one embodiment, the mount 36 may be positioned along an exterior surface of the injector pump 33 such that the mounting 36 may be connected to a bottom panel 29 of a housing 21 or other stable surface using one or more of any suitable fasteners, such as a bolt, a clamp, a screw, or any combination thereof.

The connectors 35 provide a conduit extending between the injector pump 33 and the fixture 34. The connectors 35 may comprise any suitable system for allowing a flow of liquid between two or more components such as: a pump union 36, elbow piping 37, and straight piping 38. The connectors 35 may be of any suitable size or shape based on the size and type of components of the water purification system 10, the pressure and/or flow requirements for the liquid flowing into and/or out of the water purification system 10, or any other relevant factor.

The fixture 34 infuses the liquid with the gas. The fixture 34 may comprise any suitable device or system for injecting the gas into the liquid. For example, the fixture 34 may be configured to receive concentrated oxygen from the gas supply 12 and infuse the water with oxygen before it exits the gas injector system 11 via outlet 16. In one embodiment the fixture 34 may be configured to provide a fluid path for the water and introduce oxygen into the fluid path. For example, the fixture 34 may comprise various pipes and connectors to create the fluid path and a region of low-pressure to draw the oxygen into the fluid path.

The fixture 34 may be positioned downstream of the injector pump 33 and be coupled to both the gas supply 12 and the connectors 35. For example, the fixture 34 may be configured to receive the flow of water from the connectors 35 into a first opening 49 and allow the gas infused water to flow out of a second opening 51.

The fixture 34 may further comprise an adapter 41 configured to provide a complementary connection to other pipes, fittings, connectors, and the like. The adapter 41 may be configured to receive an opposing component, such as a female adapter or a male adapter. In an exemplary embodiment, each of the first opening 49 and the second opening 51 may be connected to one pipe adapter 41. The one or more pipe adapters 41 may be any suitable size based on the size and type of components of the water purification system 10, the pressure and/or flow requirements for the liquid flowing into and/or out of the water purification system 10, or any other relevant factor.

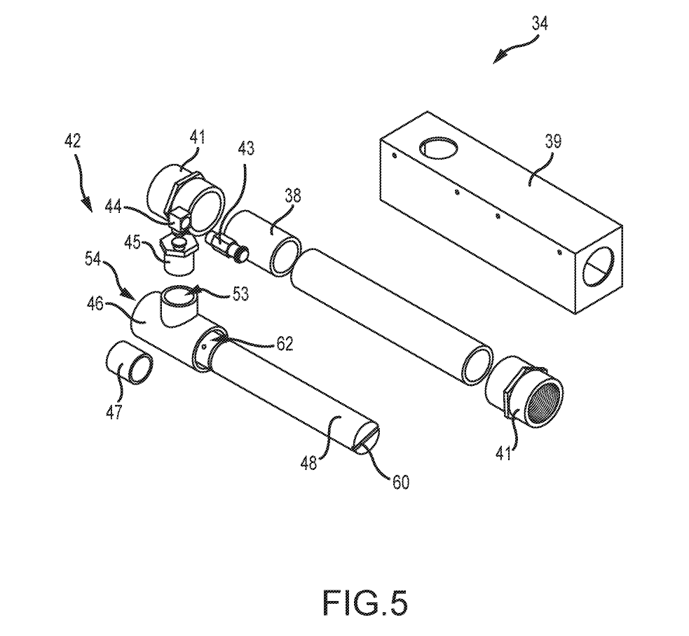

Referring now to FIG. 5, the fixture 34 may further comprise one or more straight pipes 38 to provide connections between various other components within the fixture 34. For example, the straight pipe 38 may be coupled between a tee fitting 46 and the pipe adapter 41. The one or more straight pipes 38 may be any suitable size based on the size and type of components of the water purification system 10, the pressure and/or flow requirements for the liquid flowing into and/or out of the water purification system 10, or any other relevant factor.

The fixture 34 may further comprise a valve assembly 42 configured to introduce the concentrated oxygen at a predetermined pressure and flow rate by any suitable method or system. For example, the valve assembly 42 may be coupled to the gas supply 12 to deliver the concentrated oxygen to the fixture 34. The amount of oxygen introduced into the system may vary depending on the type of system, other secondary treatment systems, the size of the reservoir and other relevant factors.

The valve assembly 42 may comprise any suitable device or system for controlling a flow rate of the gas such as a ball cock, a ball valve, a butterfly valve, a check valve, a double check valve, a gate valve, a globe valve, a hydraulic valve, a leaf valve, a non-return valve, a pilot valve, a piston valve, a plug valve, a pneumatic valve, a rotary valve, and/or the like. The valve assembly 42 may further comprise an adapter 44, a bushing 45, the tee fitting 46, and a slip combo 48. For example, in one embodiment, the valve assembly 42 may comprise an injector valve 43 coupled to the gas supply 12, and may be configured to receive oxygen from the gas supply 12 via a hose or other suitable airtight piping and/or fittings. The injector valve 43 may be adjustable to allow varying amounts of oxygen into the system, or may be fixed to allow a constant flow of oxygen. The injector valve 43 may be any suitable size based on the size and type of components of the water purification system 10, the pressure and/or flow requirements for the liquid flowing into and/or out of the water purification system 10, or any other relevant factor.

The adapter 44 may be configured to couple the injector valve 43 to the valve assembly 42. For example, the adapter 44 may be configured as an elbow and may be configured to receive the injector valve 43 through a male-to-female connection. The adapter 44 may be any suitable size based on the size and type of components of the water purification system 10, the pressure and/or flow requirements for the liquid flowing into and/or out of the water purification system 10, or any other relevant factor.

The bushing 45 may be configured to provide a connection between the adapter 44 and the tee fitting 46. For example, the bushing may be configured as a reducing bushing, or any other suitable type of bushing based on the size and type of components of the water purification system 10, the pressure and/or flow requirements for the liquid flowing into and/or out of the water purification system 10, or any other relevant factor.

The tee fitting 46 may provide an entry point for the concentrated oxygen and the liquid, where the concentrated oxygen is then injected into the liquid. The tee fitting 46 may comprise three ports for entry and exit of the liquid and/or oxygen. For example, the tee fitting 46 may be configured to allow oxygen to be introduced in the system though a main tee inlet 53 (i.e., a gas port) and allow water to flow through the remaining ports 54, where the remaining ports 54 are the openings which are 90 degrees from the main tee inlet 53. The tee fitting 46 may be configured in any dimension necessary to provide the desired amount of water flow and oxygen flow. For example, a reducing tee may be used if the system requires a tee fitting 46 with a larger main tee inlet 53 and smaller ports 54.

The slip combo 48 may be configured to disperse oxygen into the liquid in an even and controlled manner. The slip combo 48 may comprise one or more pipes and/or regions configured to deliver oxygen into the liquid. In one embodiment, a portion of the slip combo 48 may comprise a helical vane 60 and a separate portion of the slip combo 48 may comprise a region 62 with holes. For example, the region 62 with holes may be configured create a low-pressure area to draw the oxygen into the liquid and may be positioned upstream from the helical vane 60. The helical vane 60 may be configured to divide the liquid into two paths. According to an exemplary embodiment, the helical vane 60 extends along a length of the fixture between the port 54 and the outlet 16.

The slip combo 48 may be secured to the tee fitting 46 at one end, such as the end region 62 with holes. When water flows though the tee fitting 46 and slip combo 48, oxygen may be introduced into the system. For example, when the slip combo 48 is secured to one of the smaller outlets 54 of the tee fitting 46, water may flow from one smaller port 54 of the tee fitting 46 to the other smaller port 54 of the tee fitting 46 and through the slip combo 48, while the larger main tee inlet 53 may provide a conduit for oxygen.

The fixture 34 may further comprise a second filter 47 to evenly disperse the gas into the liquid. The second filter 47 may be located within the valve assembly 42 and may be use in conjunction with the slip combo 48. For example, in one embodiment, the second filter 47 may comprise a porous membrane allowing gases to disperse uniformly around the fluid flow.

The fixture 34 may further comprise a housing 39 configured to enclose all or part of the fixture 34. The housing 39 may be of any size or shape, and may be constructed of any suitable material. The housing 39 may have one or more openings adapted to receive various components of the fixture 34. For example, a portion of the valve assembly 42 may be configured to protrude from the housing 39, for example, the adapter 44 and the injector valve 43, while the other components, for example, the tee fitting 46, the bushing 45, and the second filter 47, may be enclosed within the housing 39.

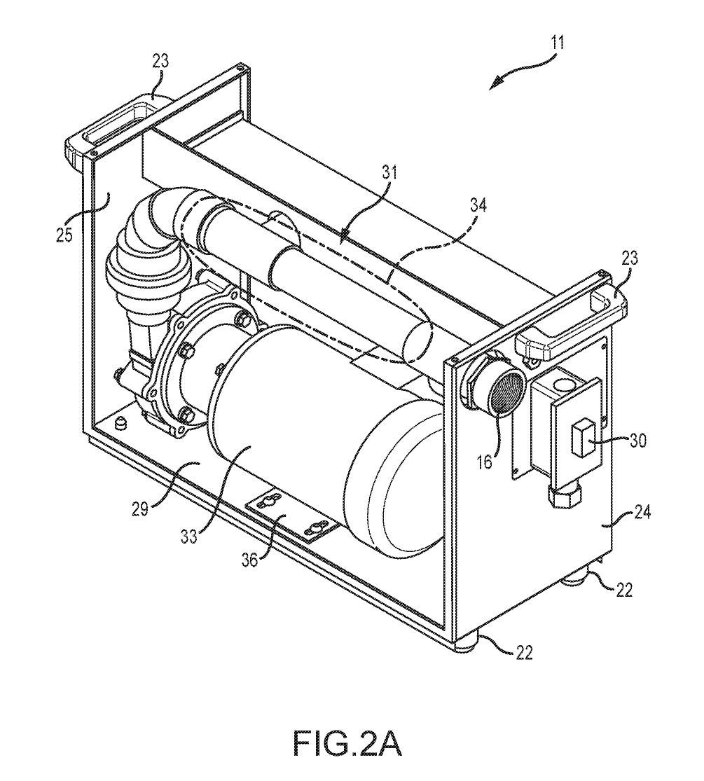

Referring again to FIGS. 2A and 2B, the housing 21 may house and protect the gas injector system 11 from environmental elements. The housing 21 may comprise a front panel 24, a back panel 25, a plurality of side panels 26, and a top and bottom panels 28, 29. The housing 21 may be constructed of any material suitable for the environmental condition for which it will be exposed to. For example, the material may comprise a material that is not prone to rusting, since the housing 21 may be exposed to water or caustic chemicals. The housing 21 may be constructed of a material adapted to maintain the structural integrity of the housing 21 in the presence of environmental conditions such as heat, as the enclosure may be exposed to direct sunlight and other sources of heat. The front panel 24 may further comprise an opening to receive the outlet 16 of the gas injector system 11. The back panel 25 may further comprise an opening to receive the inlet 15 of the gas injector system 11. To reduce the costs of manufacturing of the housing 21, the front panel 24, the back panel 25, side panels 26, 27, the top and bottom panels 28, 29 may be constructed of different materials or may be constructed of the same material. The enclosure may be constructed in way which allows easy access to the interior 31 of the housing 21 for maintenance or repair. For example, the top panel 28 may be removed independently from the front panel 24, the back panel 25, side panels 26, 27 in order to access the interior 31.

One or more vents 32 may be disposed along any one of the front panel 24, the back panel 25, side panels 26, 27, the top panel 28 and bottom 29. For example, in one embodiment, the vents 32 may be positioned on the housing 21 to facilitate air flow through the housing 21 to provide thermal cooling to interior components. The vents 32 may comprise any suitable shape and size, such has horizontal slits, circular cutouts, or any other shape and size which allows air flow into and out of the interior 31 of the housing 21. The housing 21 may also comprise an internal cooling fan configured to force air through the vents 32.

The housing 21 may further comprise one or more legs 22. The legs 22 may be suitably configured to prevent the housing 21 from touching the ground and protect the housing 21 from debris and moisture. The legs 22 may be constructed of any material such as rubber or plastics that may not degrade if exposed to water and/or other elements.

The housing 21 may further comprise one or more handles 23. The handle 23 may provide a convenient structure to carry or transport the gas injector system 11. The handle 23 may be constructed of the same material as the housing 21 or may be constructed of a different material. For example, a first handle 23 may be positioned on the front panel 24 and a second handle 23 may be positioned on the back panel 25. Each handle 23 may be shaped to provide an ergonomic design for easy transportation.

The gas injector system 11 may further comprise an on/off control 30 to operate various components of the gas injector system 11, such as the injector pump 33. The on/off control 30 may be located on an outside surface of the housing 21 for easy access to control operation of the gas injector system 11. The on/off control 30 may comprise any suitable device or system such as: a switch, a button, a lever, or the like that may be used to turn the gas injector system 11 on or off. The on/off control 30 may further comprise an automatic shut-off mechanism (not shown). The automatic shut-off mechanism may be configured as a contact switch where one contact is controlled by a pressure sensor, such that if the pump 14 is disabled, thus causing a decrease in pressure where the pressure sensor reacts to the decrease in pressure thereby separating the contacts, the injector pump 33 is also disabled.

Referring back to FIG. 1, the water purification system 10 may further comprise a bypass conduit 58 coupled between the first filter 13 and the return outlet 18 to provide a direct liquid flow route from the first filter 13 back into the reservoir 19. The bypass conduit 58 may comprise a valve 55 to control the flow of the liquid into the bypass conduit 58. For example, the water in the reservoir 19 may be cycled though the first filter 13 and back into the reservoir 19 without being infused with oxygen.

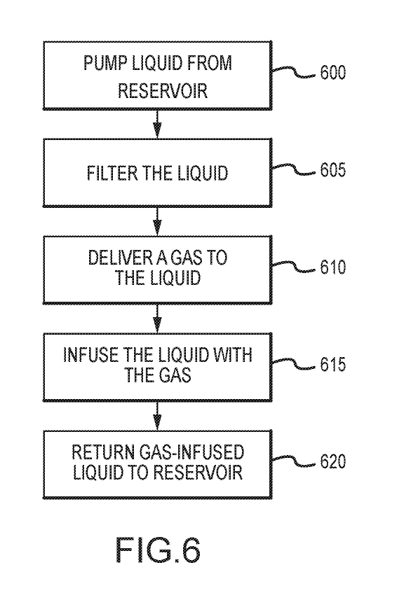

Referring to FIGS. 1-6, in operation, the water purification system 10 pumps liquid from a liquid source, injects the liquid with the gas, and returns the gas-injected liquid back into the liquid source and/or other body. The liquid from the liquid source may be cycled though water purification system 10 at any time at a users discretion, or may be set to cycle at set times throughout the day. For example, the user may want to manually turn on the system for a period of time, or the user may set the water purification system 10 to cycle every 4 hours, 8 hours, 12 hours or any other suitable period of time to elevate the amount of gas-infused liquid in the liquid source to the desired level.

In one embodiment, the pump 14 pumps liquid from the body of water, such as the reservoir 19 (600). The liquid flows through the conduit 17 to the first filter 13, where the first filter 13 filters the water to remove debris and other contaminants (605). The liquid may then be directed to the gas injector system 11 via the primary conduit 56. The injector pump 33 may facilitate the flow of the liquid through the gas injector system 11. Once the liquid reaches the gas injector system 11, the liquid is pumped into the gas injector system 11 at the inlet 15 and out of the gas injector system 11 at the outlet 16. Once the liquid is flowing through the gas injector system 11, the gas from the gas supply 12 may be introduced through the gas port 53 via the valve assembly 42 (610). The valve assembly 42 then releases the gas into the flow of liquid to produce the gas-infused liquid (615). The gas-infused liquid may then be returned to the reservoir 19 (620) via the return outlet 18.

In various embodiments, the water purification system 10 pumps the liquid from the reservoir 19, through the first filter 13, and then through the bypass conduit 58 where the liquid is returned to the reservoir 19 via the return outlet 18. In this case, the liquid is not infused with the gas before returning to the reservoir 19.

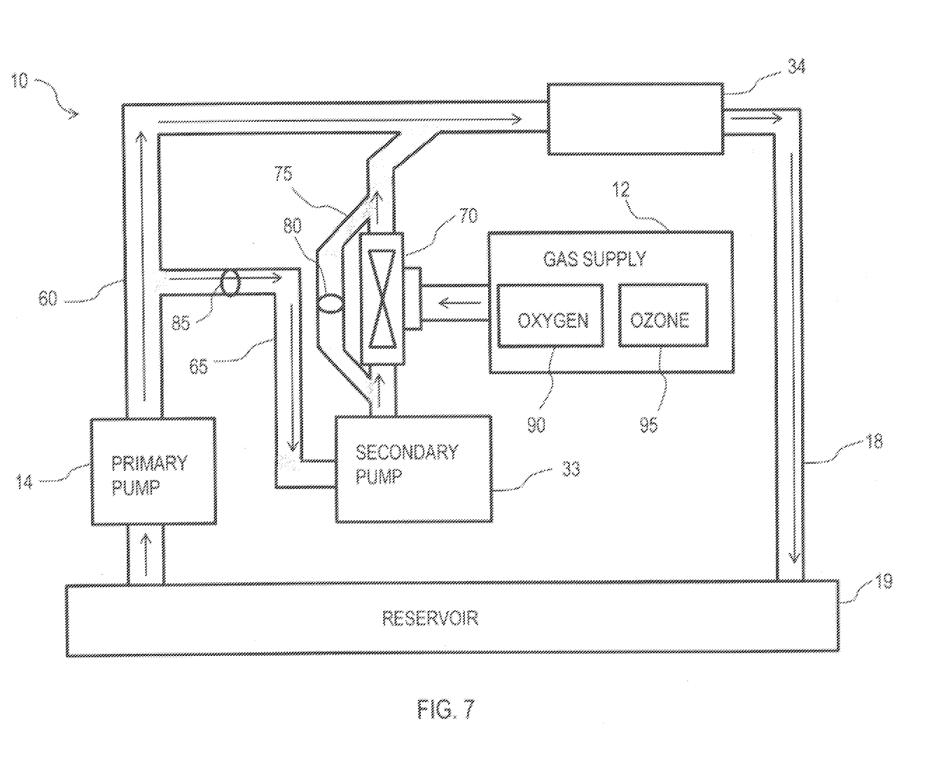

Referring to FIG. 7, in a second embodiment, the water purification system 10 is fluidly coupled to the reservoir 19 and comprises the pump 14 (i.e., primary pump 14), the injector pump 33 (i.e., secondary pump 33), the fixture 34, the gas supply 12, and a venturi valve 70. According to the present embodiment, the primary pump 14 facilitates flow of the liquid from the reservoir 19 to the fixture 34 and to the secondary pump 33. For example, the primary pump 14 pumps the liquid to the fixture through a first flow channel 60 and pumps the liquid to the secondary pump 33 through a second flow channel 65. The secondary flow channel may comprise a valve 85 to control the flow of the liquid from the primary pump 14 to the secondary pump 33. A filter, such as the first filter 13, may be fitted between the primary pump 14 and the fixture 34 and/or between the primary pump 14 and the secondary pump 33.

According to the present embodiment, the secondary pump 33 receives the liquid from the primary pump 14 and operates to provide a consistent flow of the liquid to the venturi valve 70. The venturi valve 70 may comprise a first inlet, a second inlet, and an outlet. For example, the first inlet may be connected to the secondary pump 33 and configured to receive the liquid. The second inlet may be connected to the gas supply 12 to receive one or more gasses. The venturi valve outlet may be connected to the inlet of the fixture 34. The venturi valve 70 may comprise a conventional venturi valve configured to create a suction effect to pull a gas from the gas supply 12 into the second inlet. The venturi valve 70 may function to reduce back pressure on the secondary pump 33.

The present embodiment may further comprise a bypass 75 that provides an additional and/or alternative flow path from the secondary pump 33 to the fixture 34. The bypass 75 may comprise a valve 80 to control the flow of the liquid through the bypass 75.

According to the present embodiment, the gas supply 12 may comprise oxygen gas 90 and/or ozone gas 95, and the oxygen gas 90 and ozone gas 95 may be in a concentrated form. The system 10 may be supplied to the venturi valve 70 at the same time.

According to the present embodiment, the fixture 34 may receive liquid flow from both the primary pump 14 and the venturi valve 70. For example, various conduits connecting the primary pump 14 to the fixture 34 and various conduits connecting the venturi valve to the fixture 34 may connect to each other at a point upstream of the inlet of the fixture 34. According to the present embodiment, the fixture 34 is configured to diffuse or otherwise mix the oxygen and ozone gasses 90, 95 into the liquid flowed from the primary pump 14 and expel the gas-infused liquid into the reservoir 19 through the return outlet 18.

According to various embodiments, various components of the system 10, such as various elements of the fixture 34, connectors, fittings, and the like, may be made from polycarbonate, polyvinylidene fluoride, polyvinylidene difluoride, or any other material that is non-reactive and resistant to various elements, such as solvents, acids, and bases.

As will be understood by one of ordinary skill in the art, the various components of the water purification system 10, such as the various valves, nozzles, regulator, and the like, may be coupled together directly or indirectly. Any suitable conduit may be used to indirectly couple the various components. As will also be understood by one of ordinary skill in the art, the various components, while discussed separately, may be embodied as single systems performing the functions of one or more of the described components. For example, the pump 14 may comprise a system that performs the functions of pumping the flow of liquid as well as the function of the first filter 13.

As will also be understood by one of ordinary skill in the art, the various components, including any conduit, of the water purification system 10 may be sized based on any number of factors, including flow rate and/or pressure requirements of a system the water purification system 10, is configured to couple to, the volume of liquid required to be output from the water purification system 10, mechanical tolerances and limits of the various components themselves, the liquids and/or secondary chemicals used in the water purification system 10, and the like. Similarly, one of ordinary skill in the art will understand that the various components of the gas injector system 11 may be made from any suitable material, for example copper, PVC, brass, and the like, and the choice of material may depend on the particular application of the gas injector system 11. Relevant regulations and standards, such as those promulgated by NSF International, may also affect the choice of size, material, and the like, for the various components of the gas injector system 11.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology.

1. A water purification system for a body of water contained within a reservoir capable of coupling to a gas supply to deliver a gas, comprising:
a primary pump coupled to the reservoir and configured to facilitate a first flow of water out of the reservoir;
a secondary pump coupled to an outlet of the primary pump;
a fixture configured to create a gas-infused liquid and comprising:
an inlet for receiving a second flow of water; and
an outlet for expelling the gas-infused liquid;
a venturi valve coupled to:
the secondary pump;
the gas supply; and
the fixture; and
a return outlet coupled between the outlet of the fixture and the reservoir to direct the gas-infused liquid into the reservoir.

2. The water purification system of claim 1, wherein the venturi valve is coupled between the fixture and the secondary pump and comprises:
a first inlet coupled to an outlet of the secondary pump;
a second inlet coupled to the gas supply; and
an outlet coupled to the inlet of the fixture.

3. The water purification system of claim 1, further comprising a filter coupled between the primary pump and the fixture.

4. The water purification system of claim 1, further comprising a bypass conduit configured to couple an outlet of the secondary pump to an outlet of the venturi valve.

5. The water purification system of claim 4, wherein the bypass conduit comprises a valve to control a flow of liquid from the secondary pump to the fixture.

6. The water purification system of claim 1, wherein the gas comprises oxygen gas and ozone gas.

7. The water purification system of claim 1, wherein the gas comprises at least one of:
oxygen gas and ozone gas.

8. The water purification system of claim 1, the gas-infused liquid comprises nano-bubbles, wherein the nano-bubbles are less than 1 micron in diameter.

9. The water purification system of claim 1, wherein the outlet of the primary pump is further coupled to the inlet of the fixture.

10. The water purification system of claim 1, wherein the system further comprises a control circuit configured to control power to the primary and secondary pumps.

11. A water purification system for a body of water contained within a reservoir, comprising:
a primary pump configured to provide an incoming water supply to the water purification system;
a secondary pump coupled to the primary pump;
a venturi valve coupled to an outlet of the secondary pump;
a gas supply coupled to an inlet of the venturi valve; and
a fixture coupled between the primary pump and the reservoir, comprising:
an inlet port positioned downstream of the primary pump;
an outlet port positioned downstream of the inlet port and fluidly coupled to the reservoir; and
a helical vane disposed between the inlet port and the outlet port;
wherein the fixture is configured to produce nano-bubbles in the water.

12. The water purification system of claim 11, wherein the gas comprises oxygen gas and ozone gas.

13. The water purification system of claim 11, wherein the nano-bubbles are less than 1 micron in diameter.

14. The water purification system of claim 11, further comprising a bypass conduit configured to couple an outlet of the secondary pump to the outlet of the venturi valve.

15. The water purification system of claim 14, wherein the bypass conduit comprises a valve to control a flow of liquid from the secondary pump to the fixture.

16. The water purification system of claim 11, wherein an outlet of the primary pump is directly coupled to the inlet of the fixture.

17. The water purification system of claim 11, wherein an outlet of the primary pump is coupled to an inlet of the secondary pump.

18. A method for infusing a gas into a liquid contained within a reservoir, comprising:
pumping the liquid from the reservoir with a primary pump;
pumping the liquid from the primary pump to a secondary pump through a first flow channel;
pumping the liquid from the primary pump to a fixture through a second flow channel;
delivering a gas to a venturi valve, wherein the venturi valve is coupled to an outlet of the secondary pump;
combining the liquids in the first flow channel and the second flow channel;
supplying the combined liquids to the fixture, wherein the fixture creates a gas-infused liquid; and
expelling the gas-infused liquid into the reservoir via a return outlet.

19. The method of claim 18, wherein:
the gas comprises oxygen gas and ozone gas; and
the gas-infused liquid comprises nano-bubbles, wherein the nano-bubbles are less than 1 micron in diameter.

20. The method of claim 18, further comprising providing a bypass around the venturi valve.
